(19) United States
(12) Patent Application Publication
(10) Pub. No.: US 2008/0023783 A1
(43) Pub. Date: Jan. 31, 2008

(54) Sensing capacitance in column sample and hold circuitry in a CMOS imager and improved capacitor design

(75) Inventor: Suat Utku Ay, Los Angeles, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: Micron Technology, Inc.

(21) Appl. No.: 11/494,351

(22) Filed: Jul. 25, 2006

(51) Int. Cl. H01L 31/00

(52) U.S. Cl. 257/443

(57) ABSTRACT

Improved designs for a capacitor, and particularly the sensing and references capacitors used in a column sample-and-hold (CSH) circuitry in a CMOS imager, are disclosed that minimize layout area. In-one embodiment, an additional plate layer (e.g., formed in metal 1) is provided above the traditional poly 2-poly 1 capacitor, which additional plate is shorted to traditional poly 1 bottom plate. This adds an additional area capacitance (Ca1) which is additive to the capacitance formed by the poly 2-poly 1 capacitor (Cp) to increase the total capacitance, which thus allows the capacitor to be made smaller in layout area. In another embodiment, an additional piece of metal 1 contacts the poly 2 top capacitor plate, such that a sidewall capacitance (Csw1) is defined between the sidewalls of the metal 1 pieces, which is again additive to the total capacitance. These sidewalls can be interdigitized to increase the area of the sidewall capacitance. In yet another embodiment, yet another plate layer (e.g., metal 2) is added above the metal 1 plate, which adds yet another area (Ca2) and sidewall (Csw2) capacitance to the total capacitance.

### CROSS-REFERENCE TO RELATED APPLICATIONS

This application is related to U.S. patent application Ser. No. [atty docket 102-0247US], entitled “Reduction in Size of Column Sample and Hold Circuitry in a CMOS Imager,” which is filed herewith, and which is incorporated by reference in its entirety.

### FIELD OF THE INVENTION

Embodiments of the invention relate to increasing the capacitance of the sensing capacitors in the column sample-and-hold circuitry in a CMOS imager, and relate more generally to an improved structure for a capacitor.

### BACKGROUND

Complementary Metal-Oxide-Semiconductor (CMOS) imagers are gaining popularity in the market place. As one skilled in the art understands, CMOS imagers are used to sense light and to provide an electronic representation of the sensed imaged. Accordingly, such devices are useable in digital cameras, to cite just one example.

FIG. 1 shows an example of the basic architecture of a CMOS imager 10 integrated circuit. As can be seen, the CMOS imager 10 includes an array 12 of photosensitive pixels 8 arranged in rows and columns. Read out of a given pixel 8 requires the activation of a given row and column, which is the function of the row decoder circuitry 14 and the column decoder circuitry 16, which in turn are responsive to a row address and column address input into the imager 10. The accessed pixel 8 routes a photo-induced charge from the pixel 8 to its associated column, which meets with column sample-and-hold (CSH) circuitry 18. In FIG. 1, the CSH circuitry 18 is shown at the bottom edge of the pixel array 12 (a bottom-only architecture), although it may also appear at the top and bottom of the array 12 as will be discussed further below. Briefly, the CSH circuit 18 samples the accessed pixel's charge via a sampling capacitor and a reference capacitor (more on this below) to produce signals “sig” and “rst,” which are input to an amplifier 20. The amplifier 20 in turn produces analog signals indicative of the sensed charge, and provides them to an analog-to-digital Converter (ADC) circuit 22 to provide a digital representation of the intensity of the light impingent on the pixel 8 being read.

FIG. 2 shows further details of the pixel array 12 and of the sensing circuitry, and in particular the CSH circuitry 18. As can be seen, each pixel 8 comprises a photodiode 11, which induces a charge which scales in magnitude with the intensity of the light impingent upon the photodiode. This induced charge drives a transfer gate 13 to route some amount of the power supply voltage Vcc onto a given column 15, assuming that the access transistor 17 for the row of the pixel 8 in question has been activated by the row decoders 14. Although not shown, one skilled in the art will realize that each pixel 8 may comprise a reset transistor as well.

The pixel induced charge is thus routed from the column 15 to the CSH circuitry 18, where it is coupled to two capacitors, called the sampling capacitor, Cs 32, and the reference capacitor, Cr 33. As each column has its own dedicated sampling and reference capacitors 32 and 33, they are denoted in conjunction with the column they support: i.e., the capacitors for column 0 are denoted as C0s and C0r. While the actual mechanics for using the sensing and reference capacitors 32 and 33 to sense the induced charge on the pixels 8 are well known and not directly important to embodiments of the invention, it is only briefly explained here. Essentially, a sample signal (“samp_sig”) is sent from the imager 10's control unit (not shown) to close one of transistors 19 move the charge from the column 15 onto the sampling capacitor 32 Cxs. Later in the sensing cycle, the other of the transistors 19 is opened to move charge from the column 15 to the reference capacitor 33 Cxr, which occurs in conjunction with resetting of the pixel. This provides a reference level of charge which is essentially used to normalize the signal charge. The sampled charge on Cxs and the reference charge Cxr are then passed by transistors 21 under control of a column decoder 16 at an appropriate time onto signal lines “sig” and “rst,” which are in turn passed to the amplifier 20 to perform the normalization, and ultimately to the ADC 22 where the magnitude of normalized sensed change is digitized.

Further details concerning the design and operation of CMOS imagers can be found at http://www.olympusmicro.com/primer/digitalimaging/cmosimagesensors.html, a copy of which is submitted in an Information Disclosure Statement filed with this application, and which is hereby incorporated by reference in its entirety.

FIG. 3 shows a typical layout of the sampling and reference capacitors 32 and 33 in conjunction with the pixel array 12, and FIG. 4 shows the layout of the capacitors 32 and 33 in more detail, including the connections with the columns 15 and the transistors 19 and 21 (see FIG. 2). In the embodiment shown, the capacitors 32 and 33 are positioned on both the top and bottom of the array 12 (a top-bottom architecture). So arranged, the top sets of capacitors 32t and 33t service the even-numbered columns, while the bottom sets of capacitors 32b and 33b service the odd-numbered columns.

The sensing and reference capacitors 32 and 33 in this embodiment are formed from two different layers of polycrystalline silicon (“poly 1,” “poly 2”), and as best shown in FIG. 4, the poly 1 plate 41 is formed with a slightly larger area to allow contact 44 to be easily made from the overlying metal 1 layer 43 to the bottom capacitor plate. (Note that this sizing difference between the poly 1 and poly 2 plates of the capacitors 32 and 33 is in reality quite small, and that the difference is greatly exaggerated in the Figures). As one skilled in the art of semiconductor processing will understand, a dielectric layer (such as a silicon oxide or silicon nitride) intervenes between the two capacitor plates 41 and 42.

Although the layouts of FIGS. 3 and 4 are not drawn to scale, one of skill in the art will appreciate that the CSH circuitry 18 takes up significant layout space on the imager integrated circuit. This is primarily due to the size of the sampling and reference capacitors 32 and 33. For proper sensing, it is simply the case that the capacitance of these capacitors needs to be quite large (perhaps 1.2 pF a piece). As a result, these capacitors 32 and 33 are made large in area to maximize their capacitance. Thus, even when the sampling and reference capacitors 32 and 33 are split between the top and bottom of the array 12 as shown in FIG. 3, the result is that the CSH circuitry 18 is quite long, what is referred to herein as the “column height” (CH) of the CSH circuitry 18. As can be seen in FIG. 3, this column height CH is dominated by the height h of each of the sampling and reference capacitors 32 and 33.

In any event, the column height of the CSH circuitry 18 in CMOS imagers is a significant issue, and reduction of the height is greatly desired. Without schemes to reduce this height, further miniaturization of these devices (which ultimately increases their profitability) will become increasing difficult.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 illustrates the basic circuit blocks in a CMOS imager integrated circuit.

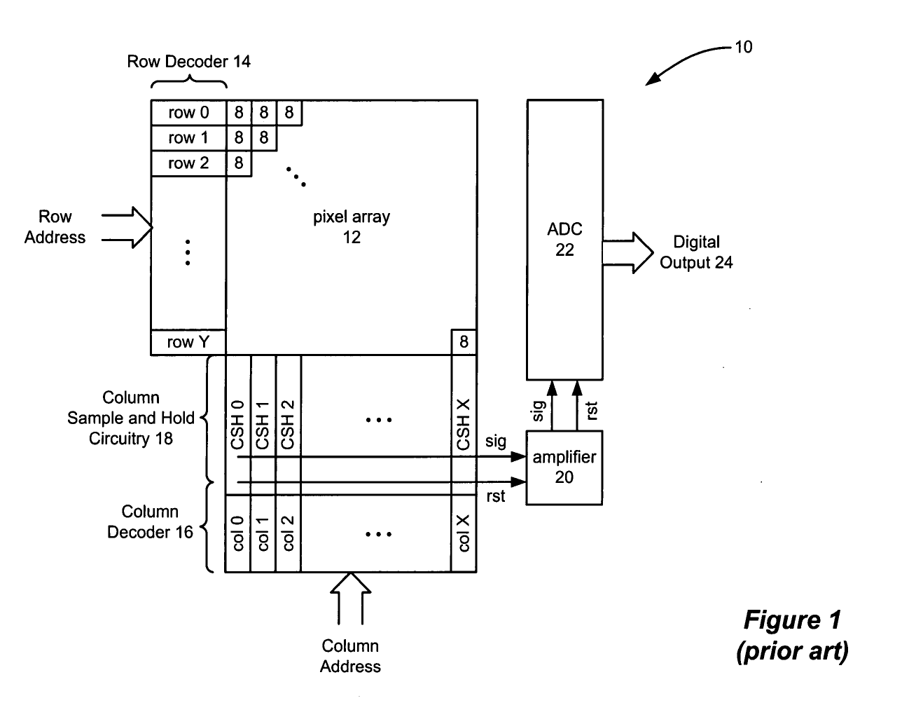

FIG. 2 illustrates the circuit schematic for the pixel array and column sample and hold (CSH) circuitry for the CMOS imager of FIG. 1.

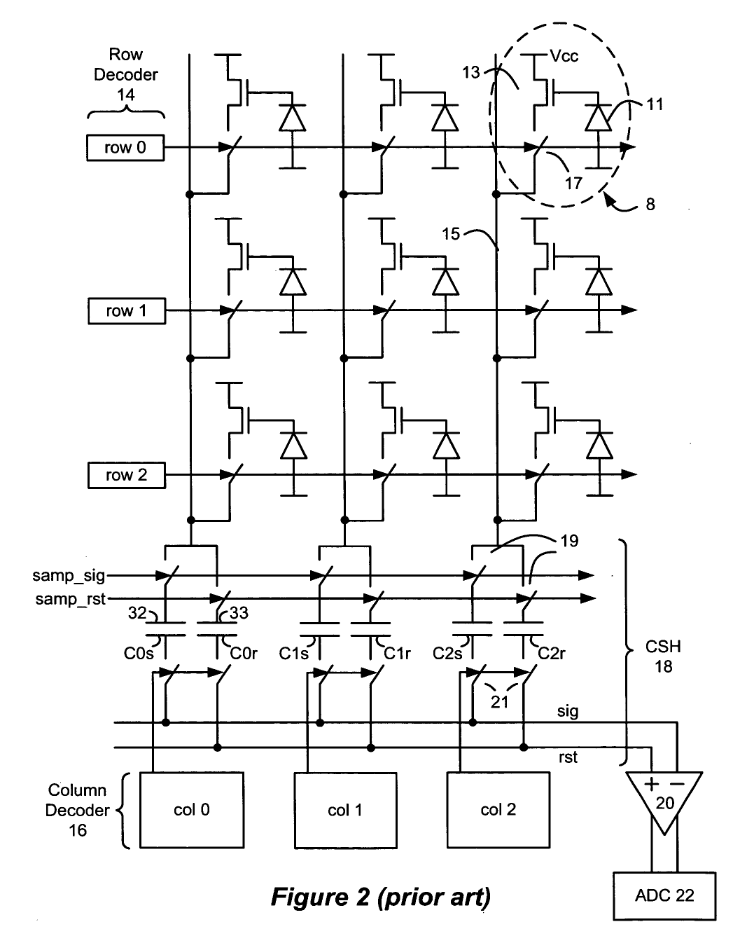

FIG. 3 illustrates the layout of the sampling and reference capacitors in the CSH circuit in accordance with the prior art.

FIG. 4 illustrates the layout of the sampling and reference capacitors in more detail than is shown in FIG. 3, including the connections with the columns and the transistors in the CHS circuitry.

FIG. 5 illustrates a first embodiment of an improved capacitor structure employing additional metal layer pieces to provide an additional area capacitance and a sidewall capacitance to the standard capacitor structure of the prior art.

FIG. 6 illustrates the nature of the sidewall capacitance of FIG. 5.

FIG. 7 illustrates how the sidewall capacitance can be increased through increasing the length of the sidewalls by interdigitizing the metal pieces.

FIG. 8 illustrates yet another embodiment of an improved capacitor structure employing additional metal layer pieces to provide an additional area capacitance and an additional sidewall capacitance to the capacitor structure of FIG. 5.

FIG. 9 illustrates how the additional sidewall capacitance can be increased through increasing the length of the sidewalls by interdigitizing the additional metal pieces.

### DETAILED DESCRIPTION

An improved design for sensing and references capacitors used in a column sample-and-hold (CSH) circuitry in a CMOS imager is disclosed. The improved design for the capacitors allows the same capacitance to be maintained, but using a smaller layout area, which allows the column height (CH) of the capacitors to be reduced.

In one embodiment, an additional plate layer (e.g., formed in metal 1) is provided above the traditional poly 2 top plate of the sensing and reference capacitors, which additional plate is shorted to traditional poly 1 bottom plate. This adds an additional area capacitance as defined by the area between the overlap of the poly 2 and metal 1 (Ca1) which is additive to the base capacitance formed by the poly 2-poly 1 capacitor (Cp). Because the total capacitance is increased, the capacitor can be made smaller in layout area. In another embodiment, an additional piece of metal 1 contacts the poly 2 top capacitor plate, such that a sidewall capacitance (Csw1) is defined between the sidewalls of the metal 1 pieces. This sidewall capacitance can be increased by increasing the length of the sidewalls, which can be accomplished by interdigitizing the metal 1 pieces to provide serpentined metal 1 sidewalls. This additional sidewall capacitance is also additive to the total capacitance, which allows for even further reduction in layout area of the capacitors.

In yet another embodiment, yet another plate layer (e.g., metal 2) is added above the metal 1 plate and coupled the poly 2 top plate (via the metal 1 layer) such that an additional area capacitance forms (Ca2) between the metal 2 and metal 1 plates which is additive to the total capacitance. Additionally, the metal 2 pieces can be brought into proximity to give rise to another sidewall capacitance, which is again additive to the total capacitance. These metal 2 pieces can additionally be interdigitized to increase this second sidewall capacitance.

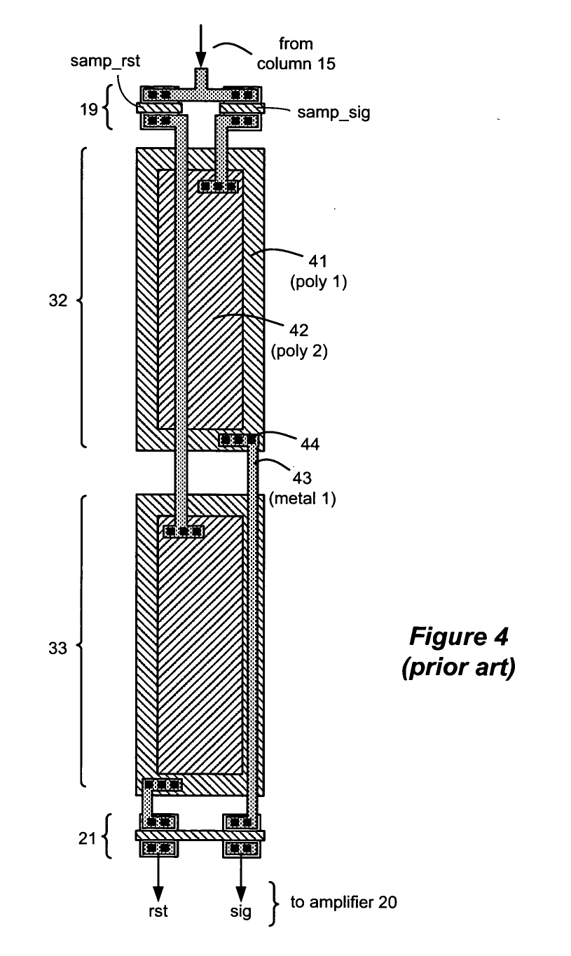

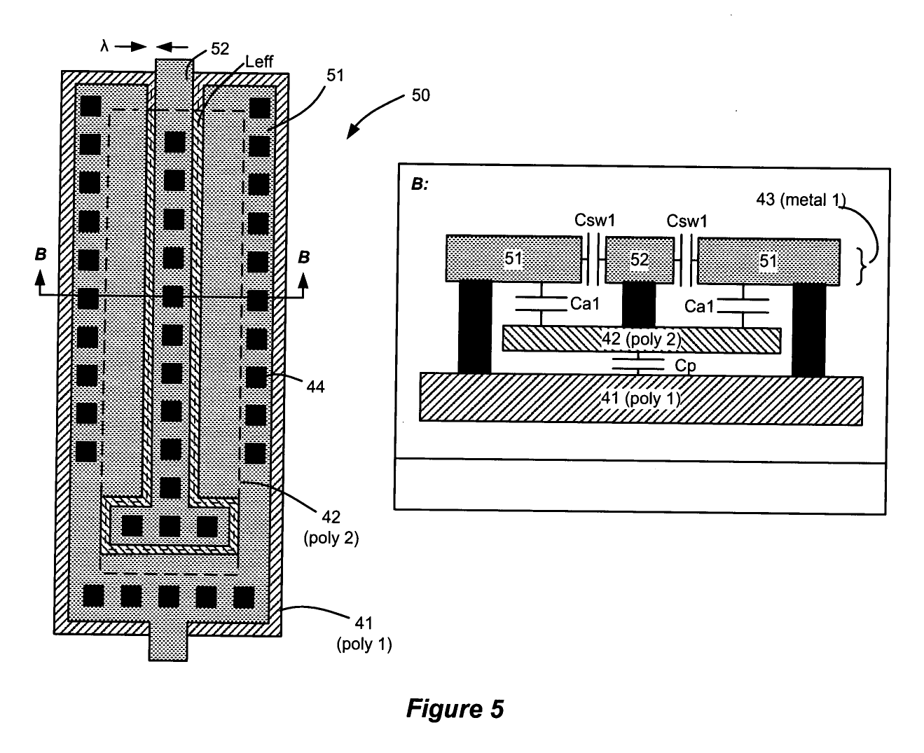

FIG. 5 shows a first embodiment 50 of the improved capacitor structure in both a top-down layout view and a cross-sectional view. The illustrated capacitor structure 50 can be used to form either or both of the sensing capacitor 32 and/or the reference capacitor 33 in the CSH circuitry 18. Because this exemplary layout can be the same for both, only one capacitor is illustrated. Having said this, one skilled in the art will realize that other conductors not illustrated would be used to couple the capacitors 32 or 33 appropriately for use in CSH circuitry, such as is illustrated in FIG. 4.

As can be seen, a first piece 51 of a metal 1 layer 43 makes contact to the poly 1 layer 41 of the capacitor, and a second piece 52 of the metal 1 layer 43 makes contact to the poly 2 layer 42 of the capacitor. These metal 1 pieces 51 and 52 can be used to connect to the CSH circuitry transistors 19 and 21 (see FIG. 4) and/or to the other capacitor 32 or 33. However, as is different from the prior art layout as shown in FIG. 4, the metal piece 51 has been formed with a substantial surface area, and essentially forms a plate. As is shown, and as is preferred, the metal piece 51 is maximized in its surface area, and in particular is maximized to cover as much of the poly 2 as possible. In this regard, one skilled in the art will recognize that the Figures are not drawn to scale to simplify illustration of aspects of the invention.

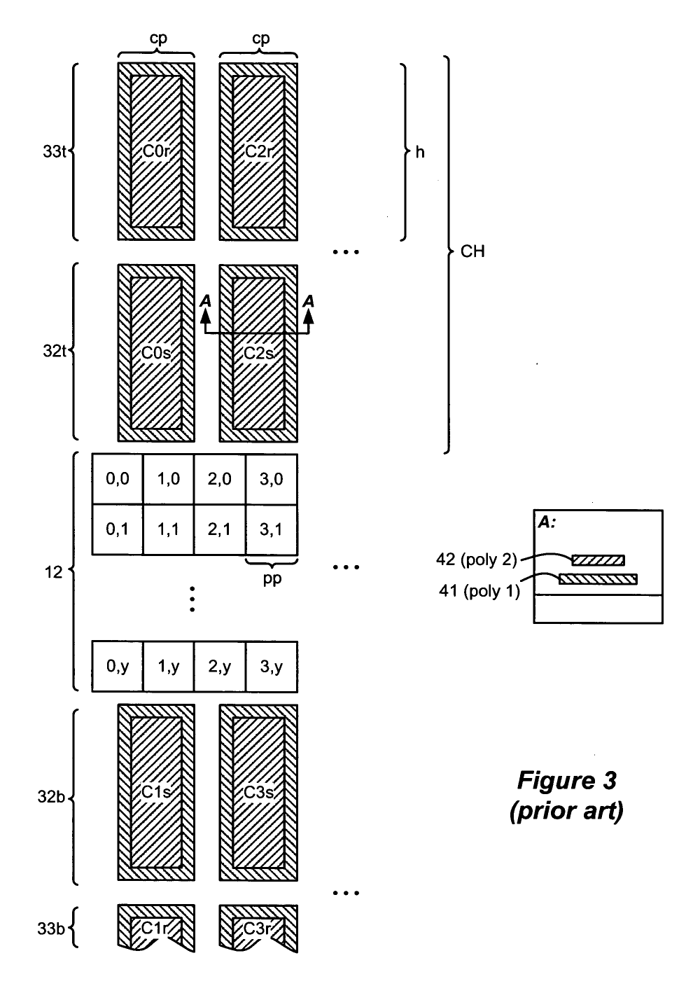

Because the metal piece 51 is tied by metal-to-poly contacts 44 to the poly 1, and because of its substantial surface area coverage of the poly 2, a second capacitance results, Ca1, which scales proportionally to the effective area (i.e., overlap; Aeff) of the metal piece 51 and the poly 2 plate 42, and scales inversely proportional to the thickness (t) of the dielectric between these layers (i.e., Ca1=ε*Aeff/t). (As one skilled in the art understands, such a dielectric between the metal 1 layer 43 and the poly 2 layer 42 usually comprises silicon oxide or silicon nitride). The additional capacitance Ca1 provided by this layout is in parallel with the otherwise base capacitance, Cp, formed by the two poly plates in the prior art. Due to the parallel configuration, these capacitances are additive, and thus the total capacitance for the improved capacitor 50, Ctot, equals Ca1+Cp. The result is therefore a higher total capacitance than that exhibited for the purely poly-based capacitors of the prior art. Or viewed differently, the improved capacitor design can provide the same capacitance as does the design of the prior art, but with a smaller layout area. The result is that the sensing capacitor 32 and the reference capacitor 33 can be made with a smaller column height (CH; see FIG. 3), which yields a more compact CSH circuitry 18 layout, and which allows for the fabrication of a smaller imager integrated circuit and its associated benefits (improved yield, lower manufacturing costs, etc.).

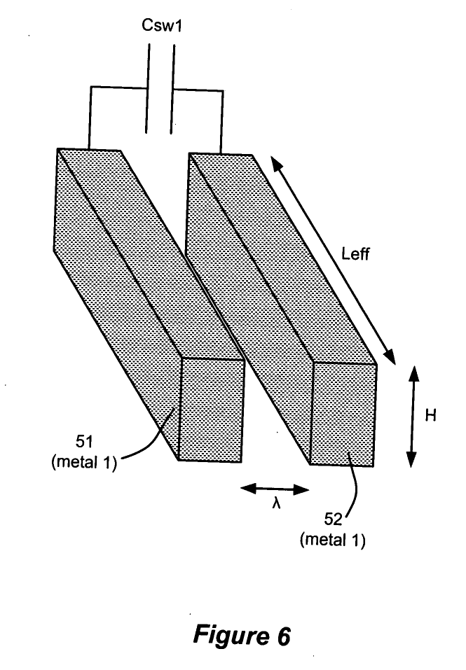

Maximizing the surface area of the metal piece 51 has other benefits which can still further increase the capacitance of the improved capacitor 50. As shown in FIG. 5, when the metal piece 51 is maximized in its surface area above the poly 2 layer 42, it is brought into close proximity to the metal piece 52 which contacts the poly 2 layer 42. In fact, design rules usually specify a minimum spacing λ between conductors in the metal 1 layer 43. As shown in FIG. 6, in modern day processes, this spacing λ can be quite small (approaching 0.1 microns), and can be significantly smaller than the thickness, H, of the metal 1 layer 43 itself (on the order of 0.3 microns). This close proximity of the sidewalls of metal pieces 51 and 52 gives rise to yet another capacitance, called the sidewall capacitance, Csw1. This lateral sidewall capacitance, Csw1, scales in proportion to the area of the sidewall, which is the metal pieces' height (H) times their effective lengths (Leff), and further scales in inverse proportion to the thickness of the dielectric between the pieces (i.e., λ), such that Csw1=ε*H*Leff/λ. Significantly then, the sidewall capacitance Csw1 scales with the effective length Leff of the spacing between two pieces 51 and 52, which length is quite significant as shown in FIG. 5. Thus, when the sidewall capacitance Csw1 is maximized and made significant through long lengths between the pieces (Leff) and finer spacings (λ), the total capacitance increases further: Ctot=Cp+Ca1+Csw1. In short, by bringing the metal 1 pieces 51 and 52 into close proximity, the capacitance of the improved capacitor structure can be further increased, allowing the capacitor to be made still smaller while retaining a suitable capacitance value for pixel charge sensing.

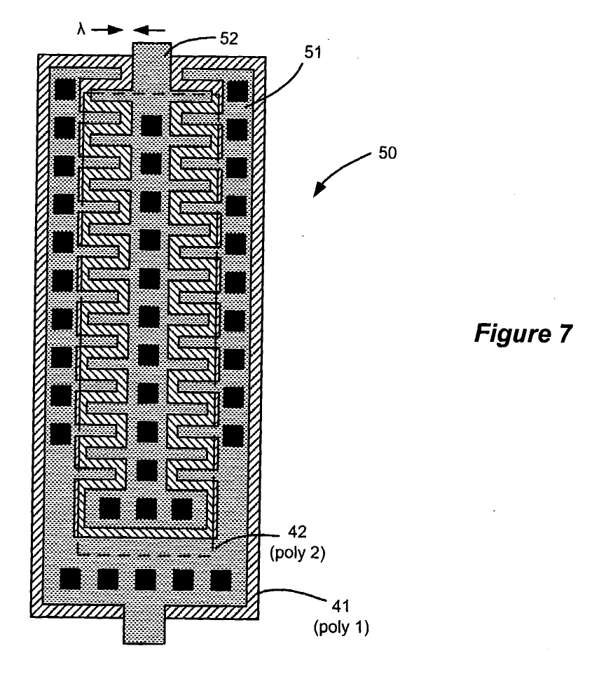

Another embodiment which even further increases the sidewall capacitance is shown in FIG. 7. As can be seen, the metal 1 pieces 51 and 52 are formed with interdigitized fingers, creating a space between them which is serpentined. Such a serpentine arrangement greatly lengthens the effective length Leff of the sidewall capacitance, and thus makes the sidewall capacitance that much more significant in adjusting the total capacitance Ctot of the improved capacitor 50. In short, by interdigitizing the metal pieces 51 and 52, the total capacitance Ctot can be still further increased, and the improved capacitor 50 can be made that much smaller.

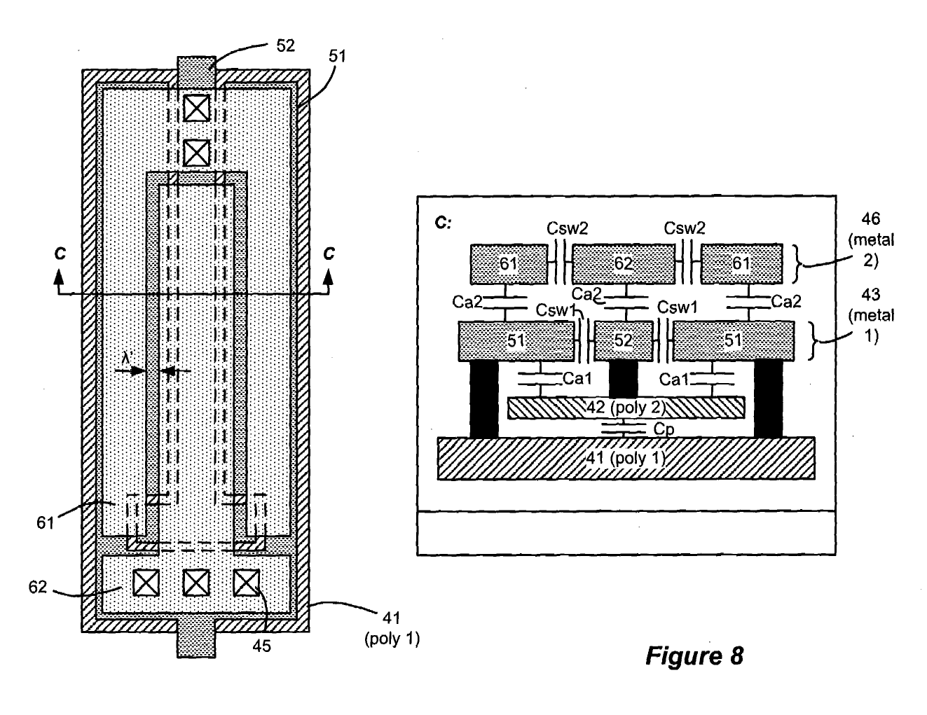

Still further embodiments can further increase the total capacitance, Ctot, and thus can allow for the fabrication of capacitors which take up even less layout area in the CSH circuitry 18. Another embodiment is shown in FIG. 8. In this embodiment, a metal 2 layer 46 is employed to add further additive capacitances to the total capacitance. Specifically, and as in shown, the metal 2 layer 46 (like the metal 1 layer) is broken into two pieces, 61 and 62. Metal 2 piece 62 is coupled to metal 1 piece 51 via metal 2-to-metal 1 contacts 45, and metal 2 piece 61 is coupled to metal 1 piece 52 via similar contacts 45. So formed, it is noticed that metal 2 piece 61 substantially overlies the entirety of the metal 1 piece 51, and so like metal piece 51, metal 2 piece 61 comprises a capacitor plate. Likewise, metal 2 piece 62 overlies metal 1 piece 52 (which pieces both might have a smaller surface area when compare with pieces 51 and 61). It is worth noting that a metal 2 layer is typically already present on an imager integrated circuit, and hence implementation of the embodiment of FIG. 8 is easily accomplished.

The configuration of FIG. 8 gives rise to yet further additive capacitances that increase the total capacitance of the improved capacitor 50. As before, the poly capacitance is present (Cp), as it the area capacitance formed by the overlap of the metal 1 pieces 51 with the poly 2 plate 42 (Ca1). The metal 1 sidewall capacitance is also present (Csw1). The addition of the metal 2 layer 46 also provides a second area capacitance (Ca2), which is defined by the overlap of the metal 2 piece 61 with the metal 1 piece 51 (and to perhaps a lesser extent, the overlap of pieces 62 and 52). Considering just these factors, it is noticed that the total capacitance is yet again increased, such that Ctot=Cp+Ca1+Csw1+Ca2, which again allows the capacitor to be made smaller in area with the benefits already mentioned.

Depending on the design-specified spacing for the metal 2 conductors, denoted as λ′ in FIG. 8, a sidewall capacitance of the metal 2 layer 46 (Csw2) can also be employed to still further increase the capacitance of the improved capacitor 50. Such metal 2 spacings λ′ are usually specified as slight larger than the spacings λ employed in the metal 1 layer, but in modern-day processes are still sufficiently small to provide a significant additional capacitance, especially if the effective length Leff of the sidewalls between the two metals 2 pieces 61 an 62 are long. When this additional factor is considered—i.e., when the metal 2 pieces 61 and 62 are brought into close proximity—the total capacitance is again increased: Ctot=Cp+Ca1+Csw1+Ca2+Csw2.

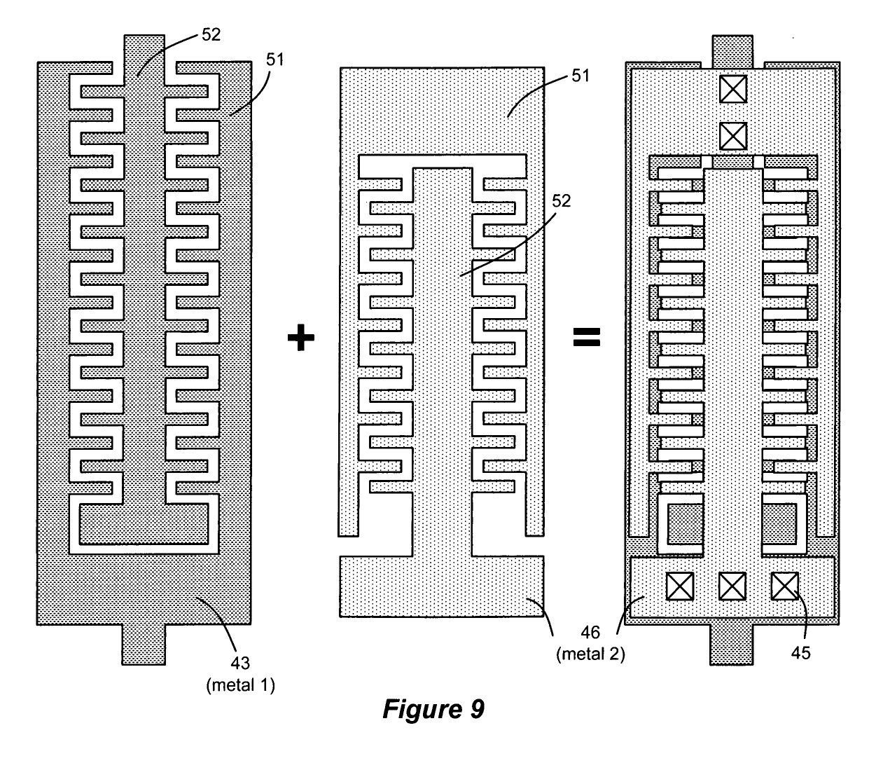

Additionally, just as with the metal 1 layer 43, the metal 2 layer 46 can be laid out so as to increase the effective length of the metal 2 sidewall capacitance, and thus increase the significance of that capacitance. As shown in FIG. 9, the metal 2 pieces 61 and 62 can be interdigitized to increase the effective length of the sidewall capacitance, Csw2, which again gives rise to an effective length which is serpentined between the two pieces. This can occur even if the metal 1 layer is not similarly interdigitized (as it is in FIG. 7). However, as shown in FIG. 9, to maximize both of the sidewall capacitance Csw1 and Csw2 of the metal layers 43 and 46, it is preferable to interdigitize both layers. To make the interdigitized fingers of each of the metal layers 43 and 46 overlap, it may be necessary to equate the spacings λ and λ′ of the two metal layers.

In any event, FIG. 9, like all of the Figures, represents only an exemplary layout for increasing the capacitance of an otherwise traditional two-plate capacitor. Many other layouts schemes can achieve the same benefits, i.e., will maximize the additive capacitances of Ca1, Csw1, Ca2, and Csw2.

Although not shown, it should be realized that the scheme of FIGS. 8 and 9 can be perpetuated such that additional overlying metal layers (metal 3, metal 4, etc.) can be employed to add further area and sidewall capacitances to the total capacitance (not shown). Because many modern-day integrated circuits already contain such additional metal layers, this can be easily accomplished, although consideration should be taken not to interfere with otherwise necessary metal signal routing.

Although the disclosed embodiments of an improved capacitor structure are disclosed as particularly useful in reducing the layout area of the sampling and reference capacitors in CSH circuitry of a CMOS imager, it should be understood that such embodiments are not so limited. Indeed, the disclosed capacitors structures can be used as a substitute and improvement for any capacitors in an integrated circuit.

It should be understood that the inventive concepts disclosed herein are capable of many modifications. To the extent such modifications fall within the scope of the appended claims and their equivalents, they are intended to be covered by this patent.

What is claimed is:

1. An imager integrated circuit, comprising:
an array of pixels arranged in a plurality of columns and rows;
a plurality of sensing circuits at at least the top of the array, wherein each sensing circuit comprises a plurality of pairs of sensing and reference capacitors, wherein the capacitors comprise:
first and second capacitor plates forming a base capacitance;
first and second conductive pieces formed in a first conductive layer over the capacitor plates, the first piece contacting the first capacitor plate and the second piece contacting the second capacitor plate,
wherein the first conductive piece forms a first additional plate substantially overlying the second capacitor plate to give rise to a first area capacitance additive to the base capacitance.

2. The imager integrated circuit of claim 1, wherein the first and second capacitor plates are respectively formed in poly 1 and poly 2.

3. The imager integrated circuit of claim 2, wherein the first conductive layer comprises a metal 1 layer.

4. The imager integrated circuit of claim 1, wherein the first and second conductive pieces are separated by a first spacing to give rise to a first sidewall capacitance additive to the base capacitance.

5. The imager integrated circuit of claim 4, wherein the first spacing comprises a minimum spacing for conductors formed in the first conductive layer.

6. The imager integrated circuit of claim 4, wherein the first and second conductive pieces are interdigitized to maximize the first sidewall capacitance.

7. The imager integrated circuit of claim 1, further comprising:
third and fourth conductive pieces formed in a second conductive layer over the first and second conductive pieces, the third piece contacting the second piece and the fourth piece contacting the first piece,
wherein the third conductive piece forms a second additional plate substantially overlying the first conductive piece to give rise to a second area capacitance additive to the base capacitance.

8. The imager integrated circuit of claim 7, wherein the second conductive layer comprises a metal 2 layer.

9. The imager integrated circuit of claim 7, wherein the third and fourth conductive pieces are separated by a second spacing to give rise to a second sidewall capacitance additive to the base capacitance.

10. The imager integrated circuit of claim 9, wherein the second spacing comprises a minimum spacing for conductors formed in the second conductive layer.

11. The imager integrated circuit of claim 9, wherein the third and fourth conductive pieces are interdigitized to maximize the second sidewall capacitance.

12. An imager integrated circuit, comprising:
an array of pixels arranged in a plurality of columns and rows;
a plurality of sensing circuits at at least the top of the array, wherein each sensing circuit comprises a plurality of pairs of sensing and reference capacitors, wherein the capacitors comprise:
first and second capacitor plates forming a base capacitance;
first and second conductive pieces formed in a first conductive layer over the capacitor plates, the first piece contacting the first capacitor plate and the second piece contacting the second capacitor plate,
wherein the first and second conductive pieces are separated by a first spacing to give rise to a first sidewall capacitance additive to the base capacitance.

13. The imager integrated circuit of claim 12, wherein the first and second capacitor plates are respectively formed in poly 1 and poly 2.

14. The imager integrated circuit of claim 13, wherein the first conductive layer comprises a metal 1 layer.

15. The imager integrated circuit of claim 12, wherein the first spacing comprises a minimum spacing for conductors formed in the first conductive layer.

16. The imager integrated circuit of claim 15, wherein the first and second conductive pieces are interdigitized to maximize the first sidewall capacitance.

17. The imager integrated circuit of claim 12, further comprising:
third and fourth conductive pieces formed in a second conductive layer over the first and second conductive pieces, the third piece contacting the second piece and the fourth piece contacting the first piece,
wherein the third and fourth conductive pieces are separated by a second spacing to give rise to a second sidewall capacitance additive to the base capacitance.

18. The imager integrated circuit of claim 17, wherein the second conductive layer comprises a metal 2 layer.

19. The imager integrated circuit of claim 17, wherein the second spacing comprises a minimum spacing for conductors formed in the second conductive layer.

20. The imager integrated circuit of claim 19, wherein the third and fourth conductive pieces are interdigitized to maximize the second sidewall capacitance.

21. A capacitor structure for an integrated circuit, comprising:
first and second capacitor plates forming a base capacitance;
first and second conductive pieces formed in a first conductive layer over the capacitor plates, the first piece contacting the first capacitor plate and the second piece contacting the second capacitor plate,
wherein the first conductive piece forms a first additional plate substantially overlying the second capacitor plate to give rise to a first area capacitance additive to the base capacitance, and
wherein the first and second conductive pieces are separated by a first spacing to give rise to a first sidewall capacitance additive to the base capacitance.

22. The capacitor structure of claim 21, wherein the first and second capacitor plates are respectively formed in poly 1 and poly 2.

23. The capacitor structure of claim 22, wherein the first conductive layer comprises a metal 1 layer.

24. The capacitor structure of claim 21, wherein the first spacing comprises a minimum spacing for conductors formed in the first conductive layer.

25. The capacitor structure of claim 24, wherein the first and second conductive pieces are interdigitized to maximize the first sidewall capacitance.

26. The capacitor structure of claim 21, further comprising:
third and fourth conductive pieces formed in a second conductive layer over the first and second conductive pieces, the third piece contacting the second piece and the fourth piece contacting the first piece,
wherein the third conductive piece forms a second additional plate substantially overlying the first conductive piece to give rise to a second area capacitance additive to the base capacitance.

27. The capacitor structure of claim 26, wherein the second conductive layer comprises a metal 2 layer.

28. The capacitor structure of claim 26, wherein the third and fourth conductive pieces are separated by a second spacing to give rise to a second sidewall capacitance additive to the base capacitance.

29. The capacitor structure of claim 28, wherein the second spacing comprises a minimum spacing for conductors formed in the second conductive layer.

30. The capacitor structure of claim 28, wherein the third and fourth conductive pieces are interdigitized to maximize the second sidewall capacitance.

31. The capacitor structure of claim 21, wherein the capacitor structure comprises either or both of the sensing or reference capacitors used in the column sample-and-hold circuitry in an imager integrated circuit.

32. A capacitor structure for an integrated circuit, comprising:
first and second capacitor plates forming a base capacitance;
first and second conductive pieces formed in a first conductive layer over the capacitor plates, the first piece contacting the first capacitor plate and the second piece contacting the second capacitor plate,
wherein the first and second conductive pieces are separated by a first spacing to give rise to a first sidewall capacitance additive to the base capacitance.

33. The capacitor structure of claim 32, wherein the first and second capacitor plates are respectively formed in poly 1 and poly 2.

34. The capacitor structure of claim 33, wherein the first conductive layer comprises a metal 1 layer.

35. The capacitor structure of claim 32, wherein the first spacing comprises a minimum spacing for conductors formed in the first conductive layer.

36. The capacitor structure of claim 35, wherein the first and second conductive pieces are interdigitized to maximize the first sidewall capacitance.

37. The capacitor structure of claim 32, further comprising:
third and fourth conductive pieces formed in a second conductive layer over the first and second conductive pieces, the third piece contacting the second piece and the fourth piece contacting the first piece,
wherein the third and fourth conductive pieces are separated by a second spacing to give rise to a second sidewall capacitance additive to the base capacitance.

38. The capacitor structure of claim 37, wherein the second conductive layer comprises a metal 2 layer.

39. The capacitor structure of claim 37, wherein the second spacing comprises a minimum spacing for conductors formed in the second conductive layer.

40. The capacitor structure of claim 39, wherein the third and fourth conductive pieces are interdigitized to maximize the second sidewall capacitance.

41. The capacitor structure of claim 32, wherein the capacitor structure comprises either or both of the sensing or reference capacitors used in the column sample-and-hold circuitry in an imager integrated circuit.

42. A capacitor structure for an integrated circuit, comprising:
first and second capacitor plates forming a base capacitance;
first and second conductive pieces formed in a first conductive layer over the capacitor plates, the first piece contacting the first capacitor plate and the second piece contacting the second capacitor plate,
wherein the first conductive piece forms a first additional plate substantially overlying the second capacitor plate to give rise to a first area capacitance additive to the base capacitance, and
third and fourth conductive pieces formed in a second conductive layer over the first and second conductive pieces, the third piece contacting the second piece and the fourth piece contacting the first piece,
wherein the third conductive piece forms a second additional plate substantially overlying the first conductive piece to give rise to a second area capacitance additive to the base capacitance.

43. The capacitor structure of claim 42, wherein the first and second capacitor plates are respectively formed in poly 1 and poly 2.

44. The capacitor structure of claim 43, wherein the first conductive layer comprises a metal 1 layer, and the second conductive layer comprises a metal 2 layer.

45. The capacitor structure of claim 42,
wherein the first and second conductive pieces are separated by a first spacing to give rise to a first sidewall capacitance additive to the base capacitance, and
wherein the third and fourth conductive pieces are separated by a second spacing to give rise to a second sidewall capacitance additive to the base capacitance.

46. The capacitor structure of claim 45, wherein the first spacing comprises a minimum spacing for conductors formed in the first conductive layer, and wherein the second spacing comprises a minimum spacing for conductors formed in the second conductive layer.

47. The capacitor structure of claim 45, wherein the first and second conductive pieces are interdigitized to maximize the first sidewall capacitance, and wherein the third and fourth conductive pieces are interdigitized to maximize the second sidewall capacitance.

48. The capacitor structure of claim 42, wherein the capacitor structure comprises either or both of the sensing or reference capacitors used in the column sample-and-hold circuitry in an imager integrated circuit.

49. A capacitor structure for an integrated circuit, comprising:
first and second capacitor plates forming a base capacitance;
first and second conductive pieces formed in a first conductive layer over the capacitor plates, the first piece contacting the first capacitor plate and the second piece contacting the second capacitor plate,
wherein the first and second conductive pieces are separated by a first spacing to give rise to a first sidewall capacitance additive to the base capacitance, and
third and fourth conductive pieces formed in a second conductive layer over the first and second conductive pieces, the third piece contacting the second piece and the fourth piece contacting the first piece,
wherein the third and fourth conductive pieces are separated by a second spacing to give rise to a second sidewall capacitance additive to the base capacitance.

50. The capacitor structure of claim 49, wherein the first and second capacitor plates are respectively formed in poly 1 and poly 2.

51. The capacitor structure of claim 50, wherein the first conductive layer comprises a metal 1 layer, and the second conductive layer comprises a metal 2 layer.

52. The capacitor structure of claim 49, wherein the first spacing comprises a minimum spacing for conductors formed in the first conductive layer, and wherein the second spacing comprises a minimum spacing for conductors formed in the second conductive layer.

53. The capacitor structure of claim 49, wherein the first and second conductive pieces are interdigitized to maximize the first sidewall capacitance, and wherein the third and fourth conductive pieces are interdigitized to maximize the second sidewall capacitance.

54. The capacitor structure of claim 49, wherein the capacitor structure comprises either or both of the sensing or reference capacitors used in the column sample-and-hold circuitry in an imager integrated circuit.
